(19) United States
(12) Patent Application Publication
(10) Pub. No.: US 2006/0258552 A1
(43) Pub. Date: Nov. 16, 2006

(54) Dawn of a new way

(76) Inventor: Gloria J. Olson, Kenosha, WI (US)

Correspondence Address: Gloria J. Olson, 11611 152nd Ave., Kenosha, WI, 53142, US

(21) Appl. No.: 11/125,979

(22) Filed: May 10, 2005

(51) Int. Cl. C11D 3/37

(52) U.S. Cl. 510/276

(57) ABSTRACT

The technical aspect of “The Dawn Of A New Way” is to use any size spray bottle and fill it with ¼ Dawn to ¾ water, tip the bottle gently to combine and then spray on stained fabrics. Severe stains can be treated with a small amount of Dawn full strength gently rubbed into the stain. Dawn for laundering purposes is an entirely new use for the product which is manufactured by Proctor and Gamble, and is promoted for washing dishes, pots, and pans.

### BACKGROUND OF THE INVENTION

In the early eighties I was living on a farm and raising four sons. Every day my farmer husband and four sons would come in with every stain imaginable on their clothing. I had tons of dirty laundry and had trouble removing ring-around-the-collar, grass stains, oil stains from the guys working on engines, etc. Proctor and Gamble had put Dawn Degreaser on the market for washing dishes and greasy pots and pans. I decided to use Dawn on my laundry.

### BRIEF SUMMARY OF THE INVENTION

In summation, Dawn tackled my laundry problems by breaking down the grease and oil stains and washing them away without harming the fabrics.

### DETAILED DESCRIPTION OF THE INVENTION

Take any size spray bottle and fill ¼ of the bottle with Proctor and Gambles Dawn dishwashing liquid and combine with ¾ water. Gently tip spray bottle up and down to mix. Now it's ready to use for laundering clothes. Spray it on shirt collars, oil, grease stains, any stained item in your laundry. For really severe stains, put a little Dawn full strength on the soiled area and gently rub in. Let stand a few minutes and launder as usual with detergent in warm water, not hot, because hot water can set the stain. Dawn will not harm fabrics. Because of it's excellent degreasing agents it tackles grease, oil, spaghetti sauce, and stains of that nature and breaks them down to wash them away when laundered with detergent in warm water. Dawn for lsundering clothes is truly “The Dawn Of A New Way” for Proctor and Gamble.

### BRIEF DESCRIPTION OF THE SEVERAL VIEWS OF THE DRAWING

Not Applicable

What I claim as my invention is:

1. “The Dawn Of A New Way” in which I use Proctor and Gamble's Dawn dishwashing liquid for laundering purposes. Proctor and Gamble primarily advertises and promotes Dawn for washing dishes and pots and pans. I claim that expanding Dawn's use to include laundering clothes is my invention, conceived by me, Gloria J. Olson.
